(19) United States
(12) Patent Application Publication
(10) Pub. No.: US 2025/0074602 A1
(43) Pub. Date: Mar. 6, 2025

(54) INTEGRATED CHILLING UNIT FOR AN AIRCRAFT GALLEY

(71) Applicant: B/E Aerospace (UK) Limited, Leighton Buzzard (GB)

(72) Inventors: Edward John Reynard Grocott, Hitchin (GB); Shahzaib Hussain Qurashi, Luton (GB); Craig T. Ohl, Maize, KS (US)

(73) Assignee: B/E Aerospace (UK) Limited, Leighton Buzzard (GB)

(21) Appl. No.: 18/737,842

(22) Filed: Jun. 7, 2024

(30) Foreign Application Priority Data
Aug. 30, 2023 (EP) 23275130.5

(51) Int. Cl. B64D 13/08; B64D 11/04; B64D 13/06

(52) U.S. Cl. CPC B64D 13/08; B64D 11/04; B64D 2013/0629

(57) ABSTRACT

An integrated chilling unit for above-counter installation in an aircraft galley. The integrated chilling unit includes a housing. The housing includes a top wall, a rear wall, a first side wall, a second side wall and a bottom wall. The integrated chilling unit also includes a door hingedly attached to the housing. An interior of the integrated chilling unit stores items for cooling. The housing includes a vacuum insulation structure, wherein the vacuum insulation structure comprises a vacuum insulation panel.

### CROSS-REFERENCE TO RELATED APPLICATIONS

This application claims priority to EP patent application Ser. No. 23/275,130.5, filed Aug. 30, 2023 and titled “INTEGRATED CHILLING UNIT FOR AN AIRCRAFT GALLEY,” which is incorporated by reference herein in its entirety for all purposes.

### FIELD

This disclosure relates to aircraft galleys, and in particular to integrated chilling units for aircraft galleys.

### BACKGROUND

It is commonplace for aircraft galleys to have removable galley inserts for chilling items, such as food and beverage items. These removable galley inserts are typically held in place by turn buttons. However, this approach to retaining chilling inserts within the galley is not the best approach for holding the galley inserts in place securely.

In addition, current chilling galley inserts typically have their own electricity supply, such as a battery, and an in-built heat exchanger for chilling their contents. Both a heat exchanger and an electricity supply may be relatively heavy and expensive. Even if an insert with a heat exchanger is powered externally, i.e. the chilling galley insert is connected to an external electricity supply, this will still result in additional complexity, cost and weight.

### SUMMARY

When viewed from a first aspect, the present disclosure provides an integrated chilling unit for above-counter installation in an aircraft galley, the integrated chilling unit comprising: a housing, comprising: a top wall; a rear wall; a first side wall; a second side wall; and a bottom wall; wherein the integrated chilling unit further comprises: a door hingedly attached to the housing to move between an open position and a closed position; wherein the housing and the door define an interior arranged to store items for cooling when the door is in the closed position; and wherein the interior is accessible for the storage and/or removal of items when the door is in the open position; wherein the integrated chilling unit further comprises: a seal arranged to seal between the housing and the door when the door is in the closed position; wherein the housing comprises at least one fixing arranged for fixedly installing the integrated chilling unit in the aircraft galley; wherein at least one of the first side wall, the second side wall, the top wall and the bottom wall comprises a vacuum insulation structure; and wherein the vacuum insulation structure comprises a vacuum insulation panel.

The door may be attached to the housing using, e.g., a piano hinge that allows the door to swing between the open and closed position.

The fixing may comprise, for example, a threaded hole arranged to receive a bolt, a threaded protrusion arranged to receive a nut, or any other type of mechanical fixing suitable for fixedly installing the integrated chilling unit in the aircraft galley.

In some examples, the rear wall defines a lower vent, proximal to the bottom wall of the integrated chilling unit; wherein the lower vent is arranged to receive cold air from an external heat exchanger and provide the cold air to the interior of the integrated chilling unit.

Proximal to the bottom wall of the integrated chill unit may be defined as closer to the bottom wall of the integrated chilling unit than the top wall of the integrated chilling unit.

In some examples, the rear wall defines an upper vent, proximal to the top wall of the integrated chilling unit, arranged to expel warmer air from the interior of the integrated chilling unit.

Proximal to the top wall of the integrated chill unit may be defined as closer to the top wall of the integrated chilling unit than the bottom wall of the integrated chilling unit.

In some examples, the first side wall and the second side wall each comprise a protrusion; wherein the protrusions extend into the interior of the integrated chilling unit; and wherein the protrusions are arranged to support a shelf for storing items.

In some examples, the vacuum insulation structure further comprises: a liner proximal to the interior of the integrated chilling unit; and an exterior cover distal to the interior of the integrated chilling unit; wherein the vacuum insulation panel is arranged between, e.g. sandwiched between, the liner and the exterior cover.

In some examples, the vacuum insulation structure further comprises a frame; wherein the frame is arranged between, e.g. sandwiched between, the liner and the exterior cover; wherein the frame defines an aperture for locating, e.g. housing, the vacuum insulation panel; wherein the vacuum insulation panel is located within the aperture; and wherein the vacuum insulation panel is at least partially enclosed, e.g. fully enclosed, within the exterior cover, the liner and the frame.

In some examples, the frame has a thickness extending at least partially, e.g. fully, between the liner and the exterior cover; wherein the vacuum insulation panel has a thickness extending at least partially, e.g. partially, between the liner and the exterior cover; wherein the thickness of the frame is greater than the thickness of the vacuum insulation panel; and wherein either: the vacuum insulation panel is attached to the liner, such that there is a gap between the vacuum insulation panel and the exterior cover; or the vacuum insulation panel is attached to the exterior cover, such that there is a gap between the vacuum insulation panel and the liner.

In some examples, the area of the aperture defined by the frame for locating the vacuum insulation panel is larger than the area of the vacuum insulation panel, such that there is a gap between the vacuum insulation panel and the frame.

In some examples, the liner is a stainless steel liner.

In some examples, the frame comprises an insulating material.

In some examples, the external cover comprises glass reinforced polymer.

In some examples, the door comprises a door vacuum insulation panel.

In some examples, the door comprises: a door liner proximal to the interior of the integrated chilling unit when the door is in the closed position; and an exterior door panel distal the interior of the integrated chilling unit when the door is in the closed position; wherein the door vacuum insulation panel is arranged between, e.g. sandwiched between, the door liner and the exterior door panel.

In some examples, the door further comprises a door vacuum insulation panel frame; wherein the door vacuum insulation panel frame is arranged between the door liner and the exterior door panel; wherein the door vacuum insulation panel frame defines a door vacuum insulation panel aperture for locating, e.g. housing, the door vacuum insulation panel; wherein the door vacuum insulation panel is located within the door vacuum insulation panel aperture; and wherein the door vacuum insulation panel is at least partially, e.g. fully, enclosed within the exterior door panel, the door liner and the door vacuum insulation panel frame.

When viewed from a second aspect, an aircraft galley comprises the integrated chilling unit of any of the previous examples.

In some examples, the aircraft galley further comprises the external heat exchanger arranged to provide cold air to the interior of the integrated chilling unit.

### BRIEF DESCRIPTION OF THE DRAWINGS

One or more non-limiting examples will now be described, by way of example only, and with reference to the accompanying figures in which:

FIG. 1 shows an integrated chilling unit installed within an aircraft galley;

FIG. 2 shows a simplified view of an integrated chilling unit for an aircraft galley;

FIG. 3 shows a more detailed view of the integrated chilling unit of FIG. 2;

FIG. 4 shows an exploded view of a side wall of the integrated chilling unit of FIG. 2;

FIG. 5 shows an exploded view of the structure of the door of the integrated chilling unit of FIG. 2;

FIG. 6 shows a cross-sectional view of the side wall of FIG. 4; and

FIG. 7 shows the rear wall of the integrated chilling unit of FIG. 2.

### DETAILED DESCRIPTION

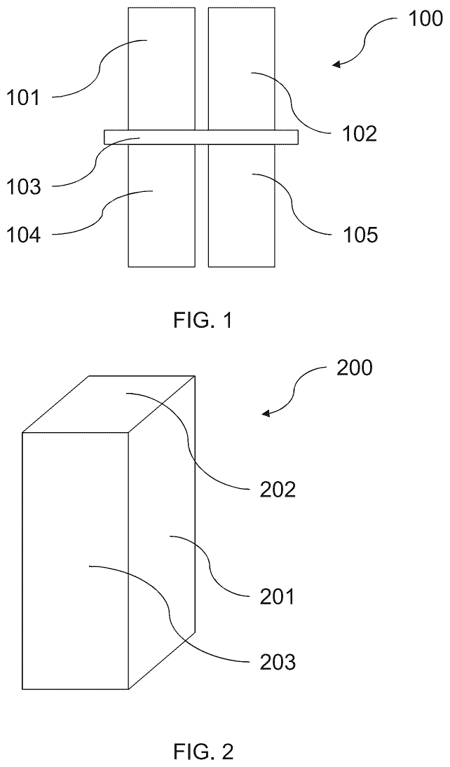

FIG. 1 shows an integrated chilling unit 101 installed within an aircraft galley 100. The integrated chilling unit 101 is used for storing and chilling food and beverage items. The integrated chilling unit 101 is installed above waist height within the galley, for ease of access by the aircraft cabin staff. FIG. 1 also shows a counter 103 below the integrated chilling unit 101. The counter 103 may be used to handle the contents of the integrated chilling unit 101, hence it is convenient for the aircraft chilling unit to be installed above the counter 103.

FIG. 1 also shows a second aircraft galley unit 102, which may be another integrated chilling unit.

FIG. 1 further shows a first galley trolley cooling compartment 104 and a second galley trolley cooling compartment 105. These compartments 104, 105 are arranged to receive cooling air from a heat exchanger (not shown) which may be installed, for example, in the ceiling above the aircraft galley 100. Typically, cooling air is supplied to the compartments from the heat exchanger via ducting. The trolley cooling compartments 104, 105 are arranged for stowing trolleys for serving food and beverage items to passengers. When the trolleys are stowed within the compartments 104, 105, the cooling air supplied by the heat exchanger cools the trolleys.

FIG. 2 shows a simplified view of an integrated chilling unit 200 for an aircraft galley. The chilling unit may be the chilling unit 101 of FIG. 1. The chilling unit 200 comprises side walls 201, a top wall 202 and a bottom wall (not shown), a door 203, and a rear wall (not shown). Together, the side walls 201, the top wall and the bottom wall comprise the housing of the integrated chilling unit 200. The door 203 is attached, e.g. using a piano hinge type attachment (not shown), to the housing in order to move between an open and closed position. The interior of the integrated chilling unit 200 is defined by the side walls 201, the top wall 202, the bottom wall and the door 203, when the door is closed. The interior stores food and beverage items for chilling in an aircraft galley.

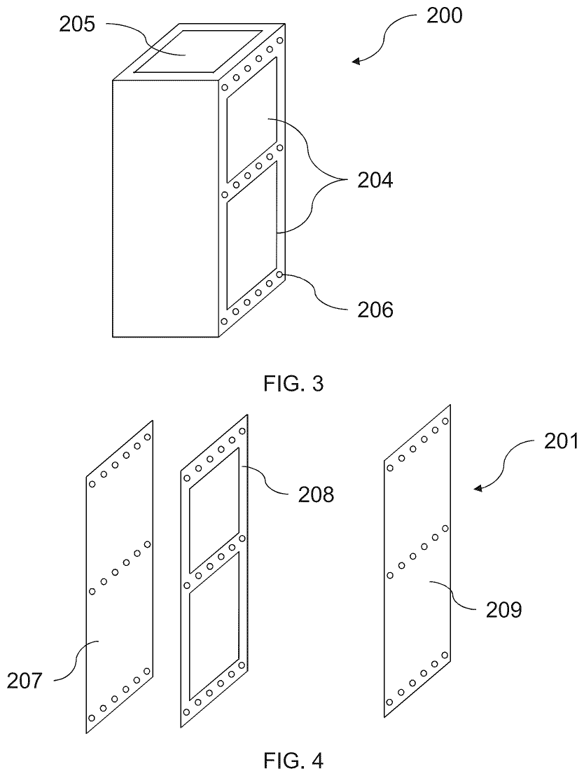

FIG. 3 shows a more detailed view of the integrated chilling unit 200 of FIG. 2. In FIG. 3, side vacuum insulation panels 204 and a top vacuum insulation panel 205 can be seen. These vacuum insulation panels 204, 205 provide insulation to the integrated chilling unit 200 in order to help maintain the temperature of the chilling unit 200. This insulation may allow for more energy efficient operation of the integrated chilling unit 200, as less energy may be required to maintain the temperature of the integrated chilling unit 200.

The vacuum insulation panels 204, 205 are particularly effective at insulating the integrated chilling unit 200. Vacuum insulation panels 204, 205 may be defined as a thermal insulation panels evacuated of air, and vacuum-sealed. Due to their near-complete absence of air, vacuum insulation panels 204, 205 conduct very little heat. This provides excellent thermal efficiency. In addition to the thermal insulation benefits provided by vacuum insulation panels 204, 205, they may also be very light-weight and thin. This may be particularly advantageous in aerospace applications.

The integrated chilling unit 200 also comprises a plurality of fixings 206 for fixedly installing the integrated chilling unit 200 into an aircraft galley, such as aircraft galley 100. These fixings 206 ensure that the integrated chilling unit 200 is installed securely within the aircraft galley, and therefore there may be less risk of the integrated chilling unit 200 moving or dislodging when the aircraft experiences turbulence. FIG. 3 shows fixings 206 in the side wall 201 of the integrated chilling unit 200. In some examples, such fixings may be present on the top wall 202, the bottom wall and/or the rear wall 206.

FIG. 4 shows an exploded view of a side wall 201 of the integrated chilling unit 200. FIG. 4 shows the vacuum insulation panels 204 sandwiched between a stainless steel liner 207 of the side wall 201 and a glass reinforced polymer cover 209. Stainless steel is a particularly suitable material for the liner 207 of the integrated chilling unit 200 as it is easy to clean and is appropriate for environments where hygiene is important. Glass reinforced polymer is suitable for the cover 209 as it is light-weight and robust.

The vacuum insulation panels 204 are positioned within an aperture in a frame 208 made from another insulating material. The material from which the frame 208 is made is more robust than the vacuum insulation panels 204, and therefore may provide protection to the vacuum insulation panels 204 to prevent the vacuum seal from braking. As the frame 208 also has thermal insulation properties, it also provides thermal insulation to the integrated chilling unit 200.

In this example, the vacuum insulation panels 204 are attached to the glass reinforced cover 209 using double sided tape. In this example, the insulation frame 208 is bonded to the stainless steel liner 207 using an adhesive, such as an epoxy resin. In this example, the insulation frame 208 is also bonded to the glass reinforced cover 209 using an adhesive, such as an epoxy resin.

In this example, the structure of the top wall 202 is similar to the structure of the side walls 201. However, the top wall only comprises a single vacuum insulation panel 205.

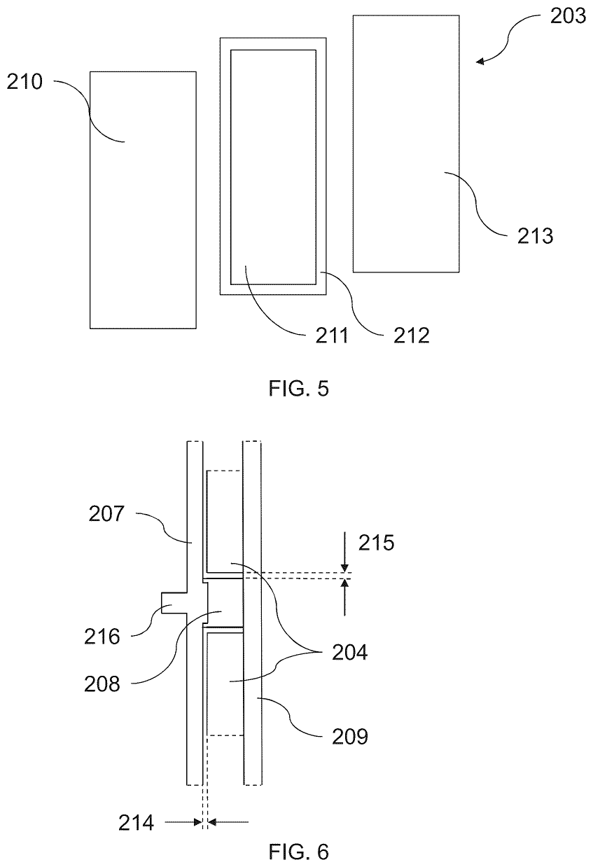

FIG. 5 shows an exploded view of the structure of the door 203 of the integrated chilling unit 200. The door 203 comprises a stainless steel door liner 213, a door vacuum insulation panel 211, a door insulation frame 212 and an exterior door panel 210.

In this example, the vacuum insulation panel 211 is taped to door panel 210. Structural adhesive is used to bond the frame 212 to both the door panel 210 and the liner 213. The door is assembled to the integrated galley chilling unit 200 at the hinges using fixings (not shown).

The door 203 further comprises a seal (not shown) around the outer edges of the door 203. The seal creates an air-tight barrier around the door to prevent cold air escaping the integrated chilling unit 200 when the door 203 is closed.

FIG. 6 shows a cross-sectional view of the side wall 201. In this figure, the vacuum insulation panels 204 and the frame 208 are bonded to the cover 209. The frame 208 is also bonded to the liner 207. A first gap 214 between the liner 207 and the vacuum insulation panels 204 is shown in the Figure. This first gap 214 is as a result of the insulation frame 208 being thicker than the vacuum insulation panel 204. The first gap 214 protects the vacuum insulation panel 204 from damage by ensuring that the vacuum insulation panel 204 does not come into contact the liner 207. The top wall 202, the bottom wall and the door 203 may have a similar construction, with corresponding first gaps between the vacuum insulation panels 205, 211 and the cover and door panel 210 respectively.

There is also a second gap 215 between the vacuum insulation panels 204 and the insulation frame 208 to ensure that the vacuum insulation panels 204 do not contact the insulation frame 208 and are therefore protected from damage. The second gap results from the apertures for the vacuum insulation panels 204 in the frame 208 being larger than the vacuum insulation panels that are located in them, i.e. having a larger footprint than the footprint of the vacuum insulation panels that are positioned within the apertures.

The first gap 208 and the second gap 215 may account for manufacturing tolerances to allow for inaccuracies in the manufacturing process of any of the parts of the side wall 201. The top wall 202, the bottom wall and the door 203 may have a similar construction, with corresponding second gaps between the vacuum insulation panels 205, 211 and the insulation frames 212.

FIG. 6 also shows that the liner 207 comprises a protrusion 216 for supporting a shelf. The opposite side wall 201 comprises a similar protrusion, and a shelf may be placed on top of the protrusions. The shelf (not shown) may be fixedly connected to the protrusions 216 in order to hold it in place when the aircraft experiences turbulence.

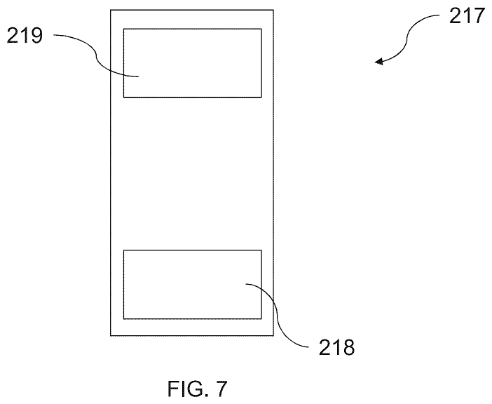

FIG. 7 shows the rear wall 217 of the integrated chilling unit 200. Cold air from a heat exchanger is supplied to a lower vent 218 via ducting (not shown). The heat exchanger from which supplies the cold air may also be used to cool aircraft galley trolley compartments, such as those shown in FIG. 1. The warm air, which has been heated up as a result of cooling the integrated chilling unit 200, leaves the chilling unit 200 via the upper vent 219. As a result of utilizing a heat exchanger external to the integrated chilling unit 200, no power supply is necessary to the integrated chilling unit 200 and it does not require its own heat exchanger.

1. An integrated chilling unit for above-counter installation in an aircraft galley, the integrated chilling unit comprising:
a housing, comprising:
a top wall;
a rear wall;
a first side wall;
a second side wall; and
a bottom wall;
wherein the integrated chilling unit further comprises:
a door hingedly attached to the housing to move between an open position and a closed position;
wherein the housing and the door define an interior arranged to store items for cooling when the door is in the closed position; and
wherein the interior is accessible for the storage and/or removal of items when the door is in the open position;
wherein the integrated chilling unit further comprises:
a seal arranged to seal between the housing and the door when the door is in the closed position;
wherein the housing comprises at least one fixing arranged for fixedly installing the integrated chilling unit in the aircraft galley;
wherein at least one of the first side wall, the second side wall, the top wall and the bottom wall comprises a vacuum insulation structure; and
wherein the vacuum insulation structure comprises a vacuum insulation panel.

2. The integrated chilling unit as claimed in claim 1, wherein the rear wall defines a lower vent, proximal to the bottom wall of the integrated chilling unit;
wherein the lower vent is arranged to receive cold air from an external heat exchanger and provide the cold air to the interior of the integrated chilling unit.

3. The integrated chilling unit as claimed in claim 1, wherein the rear wall defines an upper vent, proximal to the top wall of the integrated chilling unit, arranged to expel warmer air from the interior of the integrated chilling unit.

4. The integrated chilling unit as claimed in claim 1, wherein the first side wall and the second side wall each comprise a protrusion;
wherein the protrusions extend into the interior of the integrated chilling unit; and
wherein the protrusions are arranged to support a shelf for storing items.

5. The integrated chilling unit as claimed in claim 1, wherein the vacuum insulation structure further comprises:
a liner proximal to the interior of the integrated chilling unit; and
an exterior cover distal to the interior of the integrated chilling unit;
wherein the vacuum insulation panel is arranged between the liner and the exterior cover.

6. The integrated chilling unit as claimed in claim 5, wherein the vacuum insulation structure further comprises a frame;
wherein the frame is arranged between the liner and the exterior cover;
wherein the frame defines an aperture for locating the vacuum insulation panel;
wherein the vacuum insulation panel is located within the aperture; and
wherein the vacuum insulation panel is at least partially enclosed within the exterior cover, the liner and the frame.

7. The integrated chilling unit as claimed in claim 6, wherein the frame has a thickness extending at least partially between the liner and the exterior cover;
wherein the vacuum insulation panel has a thickness extending at least partially between the liner and the exterior cover;
wherein the thickness of the frame is greater than the thickness of the vacuum insulation panel;
and wherein either:
the vacuum insulation panel is attached to the liner, such that there is a gap between the vacuum insulation panel and the exterior cover; or
the vacuum insulation panel is attached to the exterior cover, such that there is a gap between the vacuum insulation panel and the liner.

8. The integrated chilling unit as claimed in claim 6, wherein the area of the aperture defined by the frame for locating the vacuum insulation panel is larger than the area of the vacuum insulation panel, such that there is a gap between the vacuum insulation panel and the frame.

9. The integrated chilling unit as claimed in claim 5, wherein the liner is a stainless steel liner.

10. The integrated chilling unit as claimed in claim 5, wherein the frame comprises an insulating material.

11. The integrated chilling unit as claimed in claim 5, wherein the external cover comprises glass reinforced polymer.

12. The integrated chilling unit as claimed in claim 1, wherein the door comprises a door vacuum insulation panel.

13. The integrated chilling unit as claimed in claim 12, wherein the door comprises:
a door liner proximal to the interior of the integrated chilling unit when the door is in the closed position; and
an exterior door panel distal the interior of the integrated chilling unit when the door is in the closed position;
wherein the door vacuum insulation panel is arranged between the door liner and the exterior door panel.

14. The integrated chilling unit as claimed in claim 13, wherein the door further comprises a door vacuum insulation panel frame;
wherein the door vacuum insulation panel frame is arranged between the door liner and the exterior door panel;
wherein the door vacuum insulation panel frame defines a door vacuum insulation panel aperture for locating the door vacuum insulation panel;
wherein the door vacuum insulation panel is located within the door vacuum insulation panel aperture; and
wherein the door vacuum insulation panel is at least partially enclosed within the exterior door panel, the door liner and the door vacuum insulation panel frame.

15. An aircraft galley comprising the integrated chilling unit as claimed in claim 1.
